(19) United States
(12) Patent Application Publication
(10) Pub. No.: US 2023/0353924 A1
(43) Pub. Date: Nov. 2, 2023

(54) MINIMAL DESIGN FOR IMPROVING EARPHONE STABILITY

(71) Applicant: APPLE INC., CUPERTINO, CA (US)

(72) Inventors: Geng Luo, Santa Clara, CA (US); Shota Aoyagi, San Francisco, CA (US); Timothy Emmott Torres, San Francisco, CA (US)

(73) Assignee: APPLE INC., CUPERTINO, CA (US)

(21) Appl. No.: 18/141,314

(22) Filed: Apr. 28, 2023

Related U.S. Application Data
(60) Provisional application No. 63/364,021, filed on May 2, 2022.

(51) Int. Cl. H04R 1/10

(52) U.S. Cl. CPC H04R 1/105; H04R 1/1016; H04R 1/1075; H04R 2460/11

(57) ABSTRACT

An earbud comprising: a device housing that defines an interior cavity; a primary acoustic port formed through the device housing; an acoustic driver disposed within the device housing and aligned to emit sound through the primary acoustic port; and a stability anchor protruding away from the device housing at a location adjacent to the primary acoustic port.

### CROSS-REFERENCES TO RELATED APPLICATIONS

This application claims the benefit of U.S. Provisional Patent Application No. 63/364,021, entitled “Minimal Design For Improving Earphone Stability,” filed May 2, 2022, hereby incorporated by reference in its entirety and for all purposes.

### FIELD

The present invention relates generally to earphones and more particularly to earphones that have an improved fit within the ear of a user.

### BACKGROUND

Earphones are a type of portable listening device that is intended to be positioned substantially within a user's ear. They can be used with a wide variety of electronic devices such as portable media players, smart phones, tablet computers, laptop computers and stereo systems. Earphones, which can also be referred to as ear-fitting headphones, include both in-ear headphones and earbuds. In-ear headphones, which are sometimes referred to as canal phones, are small headphones that include an eartip or similar structure that is inserted in the ear canal itself. Earbuds are small headphones that fit within a user's outer ear facing the ear canal but do not include an eartip or other structure that is inserted into the ear canal.

Despite the growing popularity of earphones, new and improved earphone designs are continuously being sought.

### BRIEF SUMMARY

Various embodiments of the invention pertain to earphones that provide an anchor at an exterior surface of the earphone to help secure the earphone within the ear of a user. Earphones according to the disclosed embodiments have a simple but secure fit that accommodates many different ear types independent of the size of the anti-tragus structure of a user's ear. In some embodiments the anchor can be located adjacent to the primary acoustic port of the earphone such that the anchor is positioned to engage with a surface of a user's ear at or near a periphery of the ear canal. While embodiments set forth in the present disclosure can be used with both in-ear headphones and earbuds, some embodiments are particularly well suited for earbuds that can be more susceptible to falling out or otherwise being dislodged from a user's ear during use.

In some embodiments an earphone comprises: a device housing that defines an interior cavity; a primary acoustic port formed through the device housing; an acoustic driver disposed within the device housing and aligned to emit sound through the primary acoustic port; a stability anchor protruding away from the device housing at a location adjacent to the primary acoustic port.

Various implementations of an earphone described herein can include one or more of the following features. The stability anchor can include first and second legs each having first ends coupled to and extending away from the device housing and second ends, opposite the first ends, that are joined together. The first and second legs can define an empty space between the legs and the device housing. The first leg can be configured to bend inward towards the device housing in response to a force asserted against the second leg in the direction of the first leg. The first leg can be longer than the second leg, and the first leg can be curved along its length such that a central section of the first leg is curved inward towards the device housing. The first and second legs can be formed from a soft plastic material. The first and second legs can be joined together at a location spaced apart from the device housing by a distance between 1.0 and 5.0 mm or by a distance between 1.5 and 3.5 mm. The stability anchor can include a spherical or spheroid structure that protrudes away from an exterior surface of the device housing. An apex of the spherical or spheroid structure can be spaced apart from the device housing by a distance between 1.0 and 5.0 mm or by a distance between 1.5 and 3.5 mm. The stability anchor can include an elongated structure having a length aligned with the primary acoustic port and an upper surface that is curved along a width of the elongated structure. An apex of elongated structure can be spaced apart from the device housing by a distance between 1.0 and 5.0 mm or by a distance between 1.5 and 3.5 mm. The stability anchor can be formed from a silicone material. The device housing can include a speaker housing portion and a stem portion that is coupled to and extends away from the speaker housing portion and the primary acoustic port can be formed through the speaker housing portion.

In some embodiments, an earphone comprises: a device housing that defines an interior cavity and has a first roughness across along a majority of an external surface that defines a shape of the earphone; a primary acoustic port formed through the device housing; an acoustic driver disposed within the device housing and aligned to emit sound through the primary acoustic port; and at least one friction zone formed along the device housing, the at least one friction zone protruding beyond the exterior surface of the device housing and having a second roughness that is greater than the first roughness.

Various implementations of such an earphone can include one or more of the following features. The device housing can be made from a hard, smooth plastic and the at least one friction zone can be made from a relatively soft silicone or rubber material. The device housing can be made from a hard, smooth plastic and the at least one friction zone can be a textured region formed at an exterior surface of the device housing. The at least one friction zone can have a textured surface in which the texture lays in a direction that creates more friction against a user ear when the earphone is removed from the ear than when the earphone is inserted into the ear. The earphone can include a first friction region formed at a first location on the device housing and a second friction region formed at a second location on the device housing. The first and second locations on the device housing can be locations where, when the earphone is worn in an ear by a user, the device housing contacts front and rear portions of the ear, respectively.

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 is a simplified illustration of a typical human ear;

FIG. 2 is a simplified cross-sectional illustration of a portion of a typical human ear;

FIGS. 3A-3C are simplified views of an earbud having a housing sized and shaped to fits within a portion of a human ear;

FIG. 4 is a simplified cross-sectional illustration of a portion of a typical human ear as shown in FIG. 2 with the earbud depicted in FIGS. 3A-3C positioned within the ear;

FIG. 5A is a simplified cross-sectional illustration of a portion of a human ear having a smaller than normal anti-targus;

FIG. 5B is a simplified cross-sectional illustration of the earbud depicted in FIGS. 3A-3C positioned within a human ear similar to the ear shown in FIG. 5A;

FIG. 6A is a simplified view of an earbud in accordance with some embodiments of the present invention;

FIG. 6B is a simplified enlarged view of the anchor structure shown in FIG. 6A according to some embodiments;

FIG. 7 is a simplified cross-sectional illustration of a portion of the human ear shown in FIG. 5 with an earbud according to some embodiments positioned within the ear;

FIG. 8 is a simplified view of an earbud in accordance with additional embodiments of the present invention;

FIG. 9 is a simplified view of an earbud in accordance with additional embodiments of the present invention;

FIG. 10 is a simplified illustration of the human ear shown in FIG. 1 with an earphone positioned within the ear;

FIGS. 11A, 11B are simplified perspective views of an earphone according to some embodiments; and

FIG. 11C is a simplified partial cross-sectional view of a portion of the earphone depicted in FIG. 11A.

### DETAILED DESCRIPTION

The present invention will now be described in detail with reference to certain embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known details have not been described in detail in order not to unnecessarily obscure the present invention.

### Anatomy of a Typical Human Ear

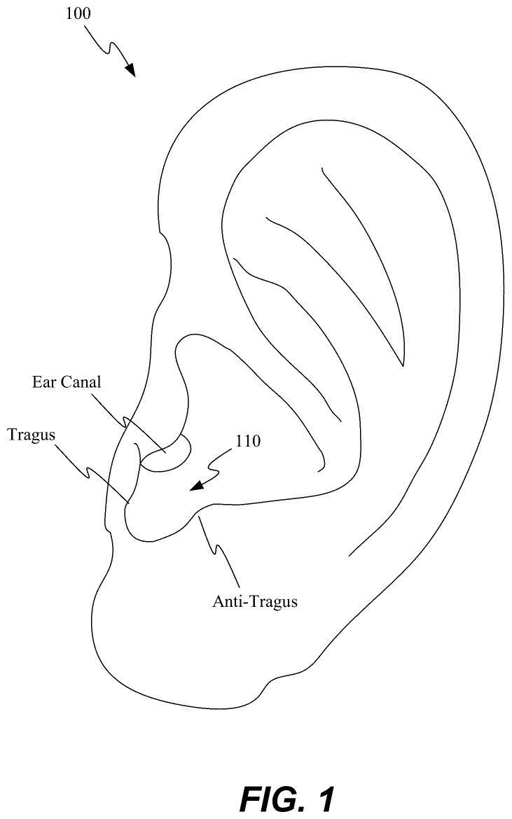

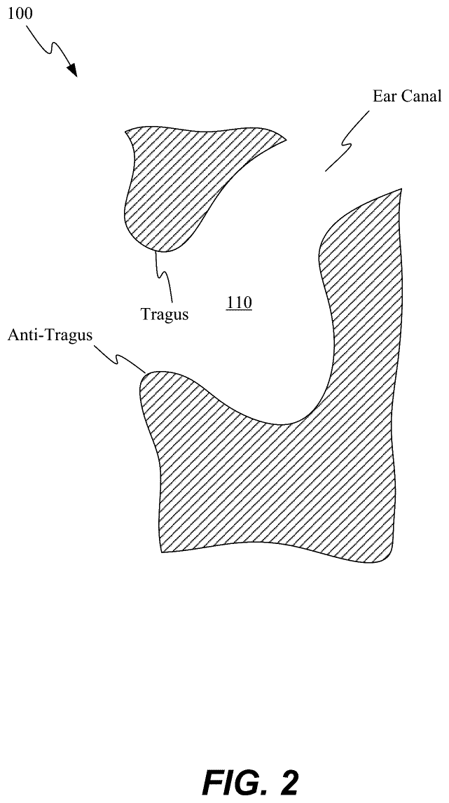

In order to better appreciate and understand the present invention, reference is first made to FIGS. 1 and 2 in which FIG. 1 is a simplified illustration of a typical human ear 100 and FIG. 2 is a simplified transverse plane cross-section illustration of a portion of ear 100. As shown in FIG. 1, human ear 100 includes a targus portion and an anti-targus portion in an opposing relationship on opposite sides of the ear canal. In this typical human ear 100, the targus and anti-targus define a channel adjacent to the ear canal. Many different earbuds include a housing that is sized and shaped to fit within channel 110 such that the housing fits within and is secured between the tragus and anti-tragus.

### The Fit of a Previously Known Earbud Within a Typical Human Ear

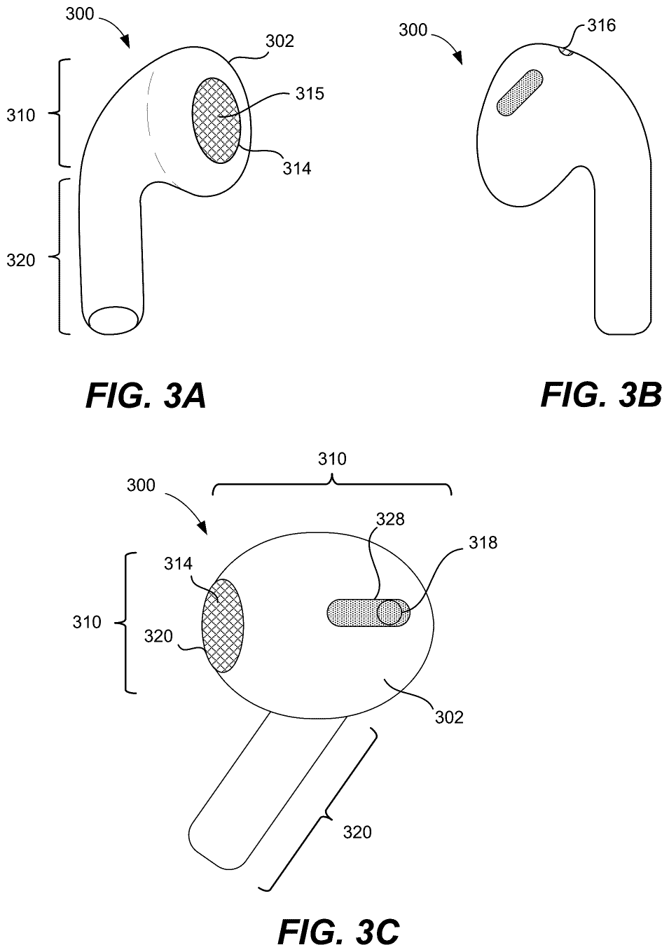

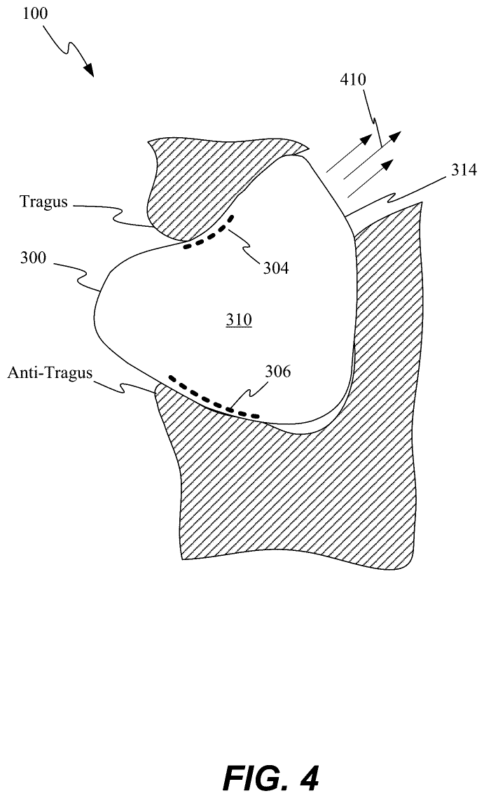

As one example of such an earbud, reference is made to FIGS. 3A-3C, which are simplified views of an earbud 300 depicted at different angles. Earbud 300 includes a housing 302 sized and shaped to fits within a portion of a human ear between the tragus and anti-tragus (i.e., with channel 110 shown in FIGS. 1 and 2). Housing 302 can form a shell that defines an internal cavity in which the various components of earbud 300 are housed. As depicted housing 302 includes two primary sections: a speaker housing 310 and a stem 320 that protrudes away from the speaker housing at an angle. The cavity portion within speaker housing 310 can hold an audio driver and battery while the cavity portion within stem 320 can hold a primary circuit board and other electronics.

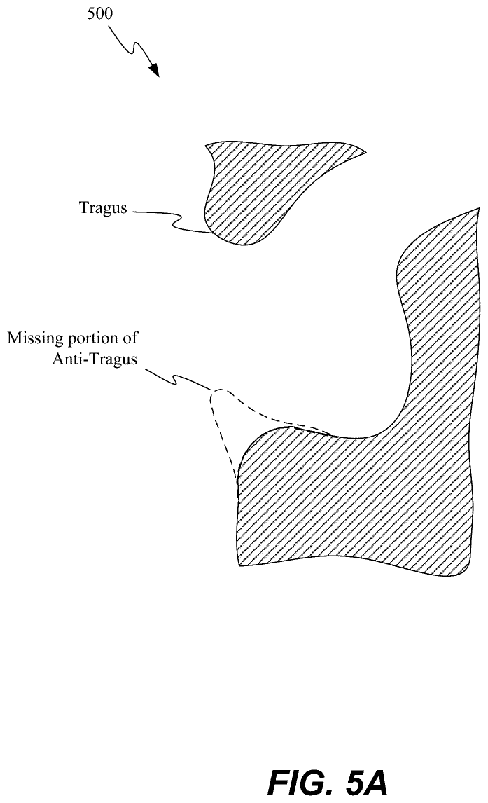

Speaker housing 310 defines a primary acoustic port 314 (shown in FIGS. 3A and 3C as being covered by a protective mesh 315) and can include one or more additional audio ports, such as base port 316 and a control leak 318 (shown in FIG. 3C behind a mesh 328). Primary acoustic port 314 is aligned such that, when speaker housing 310 is positioned within a human ear, output from the audio driver is directed through towards the ear canal (shown in FIG. 4 by sound waves 410).

Earbud 300 can have an open, unsealed acoustic architecture that is sometimes referred to as a “leaky acoustic architecture”. That is, earbud 300 does not include a deformable ear tip, which is included on in-ear headphones (also referred to as “canal phones”), that can be inserted within the ear canal and helps secure such in-ear headphones to a user's ear. Instead, a portion of housing 302, for example speaker housing 310, is sized and shaped to fit within and be secured within channel 110 by the tragus and anti-tragus. Since earbud 300 does not include an eartip, housing portion 310 is the primary support mechanism for earbud 300 when the earbud is worn by a user.

To illustrate reference is made to FIG. 4, which is a simplified cross-sectional illustration of a portion of human ear 100 taken along the same plane as that of FIG. 2. As shown in FIG. 4, portion 310 of earbud housing 302 fits within the channel formed between the tragus and anti-tragus of ear 100 when the earbud is properly positioned (i.e., worn) within ear 100. When so positioned, portions 304 and 306 of the exterior surface of housing 302 contact the tragus and anti-tragus, respectively, to secure earbud 300 to ear 100. Any force that might otherwise dislodge earbud 300 from the user's ear has to first overcome the forces applied by the tragus and anti-tragus securing the earbud within ear 100.

Anatomy of a Human Ear with a Small Anti-Tragus

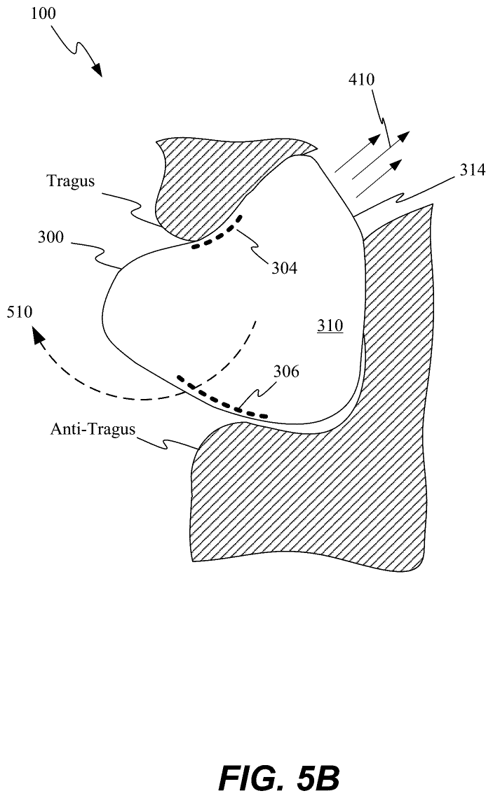

Human ear 100 depicted in FIGS. 1, 2 and 4 is representative of a typical human ear. Ears come in a variety of shapes and sizes, however, some of which have larger or smaller (or more pronounced or less pronounced) features. In some individuals the anti-tragus is considerably smaller than the anti-tragus of ear 100. For example, as shown in FIG. 5A, which is a simplified cross-sectional view of a portion of a human ear 500, a substantial portion of the anti-tragus in the ears of some individuals is missing (as indicated by the dashed line) making the anti-tragus almost non-existent in the ears 500 of such individuals.

Referring now to FIG. 5B, when an earbud, such as earbud 300, is worn by an individual having ears that are more like ear 500 than ear 100, portion 306 may have little to no contact with the anti-tragus portion of ear 500. Thus, the earbud is prone to becoming dislodged from ear 500 by rotating (as shown by arrow 510) out of the channel 110. Earbud embodiments disclosed herein solve this problem by providing an anchor or hook or other structure along an exterior surface of the earbud to more securely hold earbud 300 within a user's ear, such as ear 500.

Earbuds with a Stability Anchor

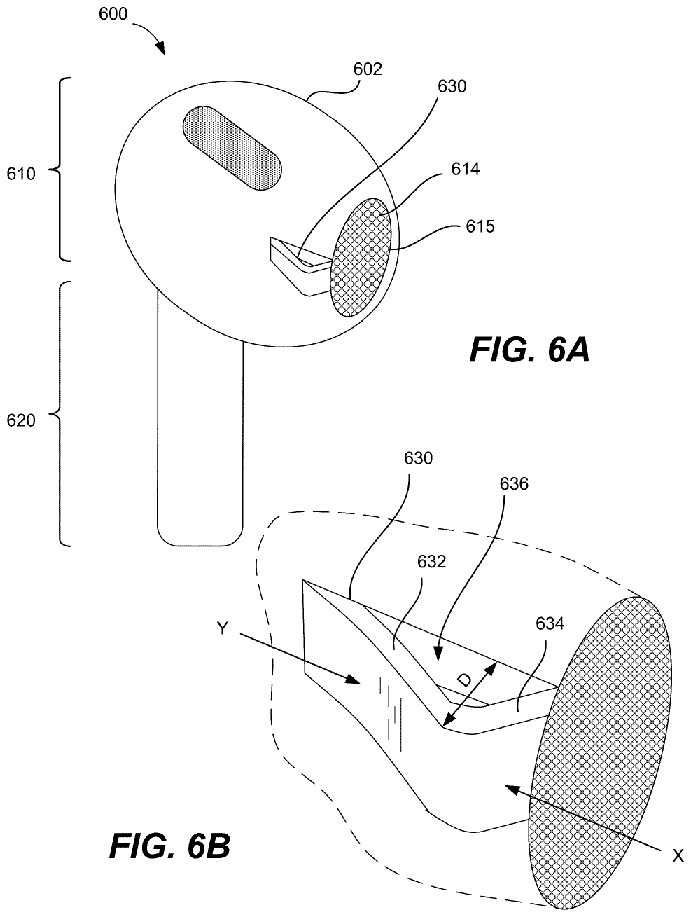

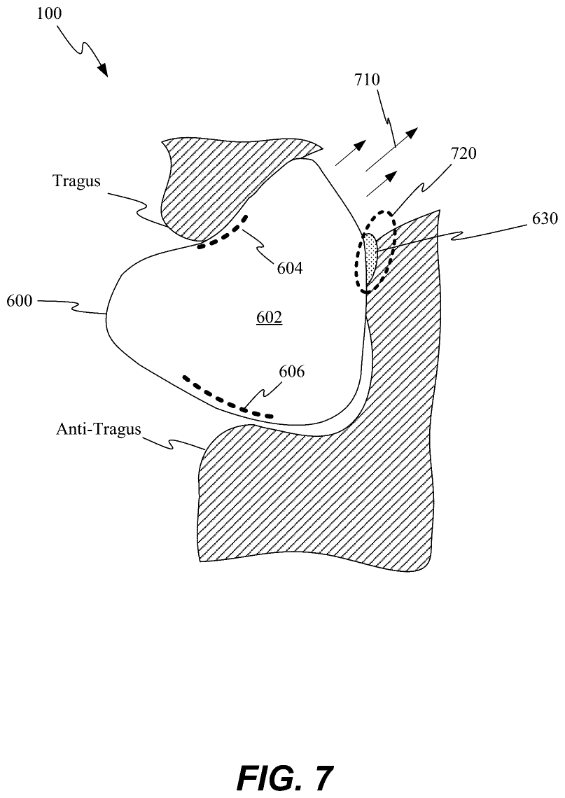

FIG. 6A is a simplified perspective view of an earbud 600 in accordance with some embodiments. Earbud 600 can be similar to earbud 300 in many aspects. For example, earbud 600 includes a housing 602 sized and shaped to fit within a portion of a human ear between the tragus and anti-tragus (i.e., with channel 110 shown in FIGS. 1 and 2) to provide an excellent and stable fit of earbud 600 for most individuals. Housing 602 can form a shell that defines an interior cavity in which the various components of earbud 600 are housed. Similar to earbud 300, housing 602 of earbud 600 can include a speaker housing portion 610 and a stem portion 320 that protrudes away from the speaker housing at an angle. The cavity portion within speaker housing 610 can hold an audio driver and battery while the cavity portion within stem 620 can hold a primary circuit board and other electronics.

Speaker housing 610 defines a primary acoustic port 614 that can be covered by a protective mesh 615. One or more additional audio ports can be included along surfaces or housing 602 but are not depicted in FIG. 6A for ease of illustration. Similar to earbud 300, earbud 600 does not include a deformable ear tip. Thus, housing portion 610, which is sized and shaped to fit within and be secured within the channel 110 (FIG. 1) between the tragus and anti-tragus, is the primary support mechanism for earbud 600 when the earbud is positioned within a user's ear.

Earbud 600 has an additional support feature, however, that enables earbud 600 to have improved stability when worn by a user having an ear with a relatively small anti-tragus, such as ear 500 shown in FIGS. 5A and 5B. Specifically, earbud 600 includes an anchor 630 positioned along a surface of earbud housing 602 adjacent to primary acoustic port 614. Anchor 630 can be designed to enable earbud 600 to have a simple but secure fit that accommodates many different ear types independent of the size of the anti-tragus structure of a user's ear. Towards this end, anchor 630 can protrude a small distance Z (e.g., between 1.0 and 5.0 mm or between 1.5 and 3.5 mm in various embodiments) away from housing 602, and the location of anchor 630 can be selected such that, when earbud 600 is properly worn by a user with acoustic port 614 aligned to emit sound into the ear canal, anchor 630 abuts an inner surface of the ear near the ear canal creating an interference fit between the earbud and the user's ear.

To illustrate, reference is made to FIG. 7, which is a simplified illustration of a cross-section of ear 500 with an earbud 600 positioned therein (i.e., with earbud 600 being worn by a user). As shown in FIG. 7, when worn within ear 500, a portion 604 (similar to portion 304 of earbud 300) along the exterior surface of housing 602 abuts the tragus portion of ear 500. Because ear 500 has a very small anti-tragus, however, portion 606 (similar to portion 306 of earbud 300) has minimal to no physical contact with the anti-tragus portion of ear 500. Thus, to secure earbud 600 within ear 500, anchor 630 is positioned to engage with an portion 720 of ear 500 near the entrance to the ear canal.

Anchor 630 can take the form of a variety of different shapes and made from a variety of different materials. In the embodiment depicted in FIG. 6A, anchor 630 has a fish-hook design that bends more easily in the direction that allows the earbud to be inserted into a human ear and bends less easily in the direction that enables the earbud to be dislodged from the ear. For example, as shown in FIG. 6B, which is an enlarged view of anchor 630, anchor 630 can have first and second legs 632 and 634 each having one end that extends away from housing 602 and second ends that are joined together where the legs 632, 634 define an empty space 636 between the legs and earbud housing 602. Leg 632 can have a slight inward bend to it that allows anchor 630 to flex or fold more easily inward into space 636 when pressed against the surface of the ear surrounding the user's ear canal and subject to a force in direction X. Leg 634, however, can be angled and formed such that the leg 634 is not as easily bent or compressed when earbud 600 is subject to a force in direction Y that would dislodge or otherwise remove the earbud from ear 500.

Anchor 630 can be made from a material that is sufficient stiff so that the anchor will not collapse when pushed against the user's ear thus enabling anchor 630 to counteract some forces that might otherwise dislodge the earbud from the ear. In some embodiments, legs 632, 634 can be made from a soft pliable plastic that can be repeatedly bent over thousands or tens of thousands of cycles without fracturing or otherwise breaking. In other embodiments, legs 632, 634 can be made from silicone or a similar synthetic elastomer material is relatively stiff but sufficiently flexible to provide a comfortable point of contact between anchor 630 and the user's ear. When made from silicon or other elastomeric material, anchor 630 can be a single solid component that does not include separate legs or an empty region between such legs. In various embodiments, anchor 630 can be made from a material that provides more friction when slid along a surface of the user's ear than the material that housing 602 is made from. For example, housing 602 can be made from a hard, smooth thermoplastic polymer, such as acrylonitrile butadiene styrene (ABS) and anchor 630 can be made from silicone or a similar material.

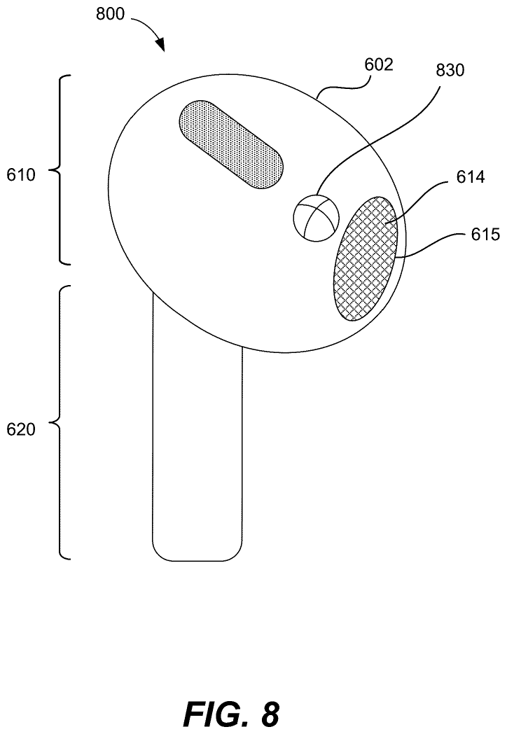

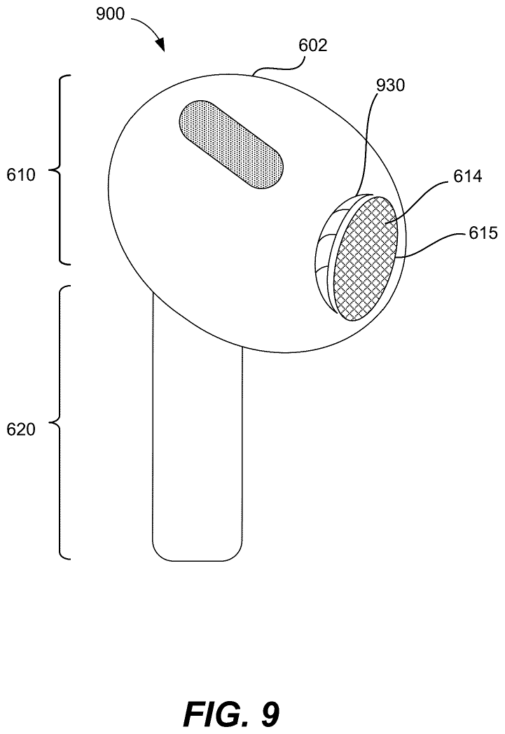

FIGS. 8 and 9 are simplified perspective views of earbuds 800 and 900 according to additional embodiments. Each of earbuds 800 and 900 includes many of the same features as earbud 600 that, for convenience, are labeled with the same reference number. Earbuds 800 and 900 also include anchors 830 and 930, respectively, that are positioned to engage with a portion 720 of ear 500 near the entrance to the ear canal in a manner similar to anchor 630. As shown in FIG. 8, anchor 830 can be a slight protrusion (e.g., a spherical, a spheroid or similar structure) that protrudes from the exterior surface of housing 602. While, as shown in FIG. 9, anchor 930 can be an elongated structure (e.g., a crescent moon-shaped structure) that extends along a length of acoustic port 614. In some embodiments, each of anchors 830 and 930 can extend, at their apex, between 1.0 and 5.0 mm or between 1.5 and 3.5 mm away from the exterior surface of housing 602. Additionally, similar to anchor 630, each of the anchors 830, 930 can also be made from a material that is sufficiently stiff that the anchors will not collapse when pushed against the user's ear but slightly flexible to allow the anchors to compress for a better and more comfortable fit within the ear. In some embodiments, each of anchors 830 and 930 can be made from silicone or a similar elastomeric material.

Each of anchors 630, 830 and 930 can be attached to housing 602 using a variety of different techniques. As one example, anchors 630 or 830 can be fabricated at the same time as housing 602 as part of a co-injection molding process. One or more holes can be formed through the housing in the anchor region and the material that the anchor is made from can extend through the holes an coat a portion of an inner surface of housing within the interior cavity formed by the housing. In other embodiments, the anchors 630, 830 and 930 can be adhered to (or chemically bonded to) housing 602 using an appropriate adhesive or bonding material.

Earbuds with Regional Friction Zones

In some embodiments, instead of including an anchor or hook, such as one of anchors 630, 830 or 930 or a similar structure, stability of an earbud or other type of earphone is increased by providing one or more high friction or “grip” zones at strategic locations along the housing of the earbud. As discussed above, the stability of an earbud is important to the overall experience and enjoyment a user might have with a pair of ear buds. If an earphone is not properly fit within a user's ear in a highly stable position, the earphone can become dislodged and may be particularly susceptible to becoming dislodged while a user is exercising or wearing the earphone during other activities that subject the earphone to various head acceleration profiles.

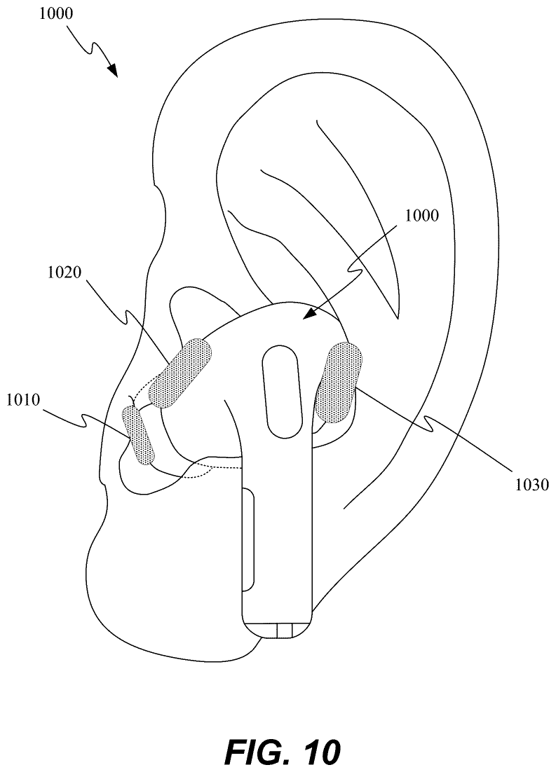

While the anchors 630, 830 or 930 are one manner of improving the stability of fit for earbuds according to some embodiments, other embodiments provide areas of increased friction or grip at select locations along an earphone housing. To illustrate, reference is made to FIG. 10 which is a simplified illustration of ear 100 shown in FIG. 1 with an earphone 1000 positioned within ear 100. As shown, earphone 1000 contacts ear 100 in three primary regions: a region 1010 in which a deformable ear tip of earphone 1000 is inserted into the ear canal, a region 1020 at a first portion of an exterior surface of earphone 1000, and a region 1030 at a second portion of the exterior surface of earphone 1000.

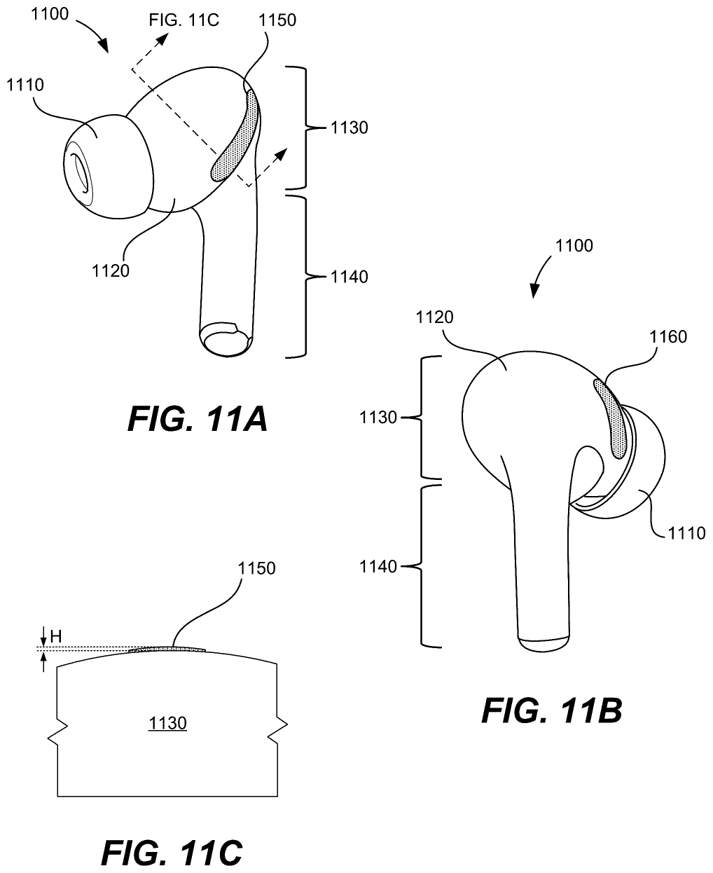

In some embodiments, the exterior surface of an earphone, such as earphone 1000, can be a relatively smooth plastic surface (e.g., a smooth ABS surface) that provides a pleasant user-experience when picking up or otherwise touching the earphone. In order to provide a more stable fit, some embodiments add areas of increased roughness or texture in one or both of the regions 1020 and 1030 that are most likely to come into physical contact with a portion of the ear when worn by a user. FIGS. 11A and 11B depict a simplified illustration of an earphone 1100 that has two such textured regions, sometimes referred to herein as “friction” regions since the regions create an increased amount of friction between the user's ear and the earphone housing as compared to portions of the housing without the textured or “friction” regions.

As shown in FIGS. 11A, 11B, earphone 1100 includes a deformable ear tip 1110 coupled to a housing 1120 that includes a speaker housing 1130 and a stem 1140. A first friction region 1150 can be formed on a first side of speaker housing 1130 at a location that is generally aligned with region 1020 (shown in FIG. 10). A second friction region 1160 can be formed on a second side of speaker housing 1130 at a location that is generally aligned with region 1030 (also shown in FIG. 10).

Each of the friction regions 1150, 1160 can provide a textured area along housing 1130 that is slightly raised and is more textured (e.g., rougher) than the relatively smooth surface of housing 1130 surrounding the areas 1150, 1160. In this manner, the friction regions 1150, 1160 provide additional “grip” between earphone 1100 and the user's ear enabling a more secure fit for earphone 1100. In some embodiments, in order to provide increased “grip”, friction regions 1150 and 1160 can also protrude slightly above the exterior surface of housing 1130 as shown in FIG. 11C, which is a simplified cross-sectional view of friction region 1150 protruding a distance, H, above the surface of housing 1130. Additionally, in some embodiments, the textured surface of friction regions 1150, 1160 can be angled (e.g., using the principles of a fish hook) such that there is more friction between the regions 1150, 1160 and a user's ear when earphone 1100 is subject to one or more forces that might dislodge the earphone or pull the earphone out of a user's ear than when the earphone is being inserted into a user's ear.

The friction regions 1150, 1160 can be created with a variety of different materials and can be formed using a variety of different techniques. In some embodiments, the friction regions 1150, 1160 and the earphone housing 1120 can be made from different materials. For example, the friction regions 1150, 1160 can be made from a relatively soft silicone, rubber or similar material while the exterior surface of the earphone housing can be a hard, smooth plastic. In other embodiments, friction regions 1150, 1160 and earphone housing 1120 can be made from the same material (e.g., a hard plastic, such as ABS) with the friction regions imprinted with a textured pattern or similar rough surface.

In various embodiments, friction regions 1150, 1160 can be a separate component that is attached or otherwise affixed to housing 1120. For example, each friction region can be thin layer that is glued or otherwise adhered to the exterior surface of housing 1130. Alternatively, each friction region 115, 1160 can be an insert with a lip extending around its periphery that is fitted through a thin slot (elongated aperture) in the housing. The lip can then be bonded (e.g., chemically or mechanically) to an interior surface of the housing to secure the insert within the aperture. In still other embodiments, friction regions 1150, 1160 can be co-molded with the housing. Accordingly, embodiments are not limited to any particular technique of forming friction regions 1150, 1160 and other techniques can be employed as would become evident to a person of skill in the art based on the present disclosure.

Furthermore, it is to be understood that the friction regions 1150, 1160 illustrated in FIGS. 11A and 11B are for illustrative purposes only. For example, while the friction regions 1150, 1160 are depicted in FIGS. 11A and 11B as relatively thin, elongated regions, the shape of the friction regions can vary greatly and embodiments are not limited to any particular shape. In other embodiments, one or both of the friction regions can have circular, oval, rectangular, triangular, asymmetric or any appropriate shape. Additionally, the actual location of one or more friction regions on a particular earphone will depend on the shape of the earphone housing and the locations at which such earphone housing contacts a human ear when worn. Thus, the locations of one or more friction regions as described herein can vary depending on the shape and size of the housing of a particular earphone. A person of skill in the art can readily determine one or more locations that are appropriate for friction regions on a given earphone housing using empirical or other data from earphone fit studies for the housing.

### Additional Embodiments

The foregoing description, for purposes of explanation, used specific nomenclature to provide a thorough understanding of the described embodiments. However, it will be apparent to one skilled in the art that the specific details are not required in order to practice the described embodiments. For example, while several specific embodiments are described above with respect to earbuds that include a stem portion (e.g., housing portion 620) extending away from a speaker housing portion (e.g., housing portion 610) embodiments are not limited to earbuds having a stem portion or similar feature. In some embodiments, the earbud housing can comprise a bulbous or similar housing structure that does not include a stem.

Thus, the foregoing descriptions of the specific embodiments described herein are presented for purposes of illustration and description. They are not intended to be exhaustive or to limit the embodiments to the precise forms disclosed. Also, while different embodiments of the invention were disclosed above, the specific details of particular embodiments may be combined in any suitable manner without departing from the spirit and scope of embodiments of the invention. For example, while embodiments described above referenced certain components as being within one or the other of housing portion 610, 620, it is to be understood that such was for illustrative purposes only. In other embodiments components of an earbud can be arranged differently than in the examples above. As illustrative examples, any of the battery, wireless circuitry, processor, antenna, microphones and other components can be located in either the stem portion or the speaker housing portion. Further, it will be apparent to one of ordinary skill in the art that many modifications and variations are possible in view of the above teachings.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

Finally, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. An earphone comprising:
a device housing that defines an interior cavity;
a primary acoustic port formed through the device housing;
an acoustic driver disposed within the device housing and aligned to emit sound through the primary acoustic port;
a stability anchor protruding away from the device housing at a location adjacent to the primary acoustic port.

2. The earphone set forth in claim 1 wherein the stability anchor comprises first and second legs each having first ends coupled to and extending away from the device housing and second ends, opposite the first ends, that are joined together.

3. The earphone set forth in claim 2 wherein the first and second legs define an empty space between the legs and the device housing, and the first leg is configured to bend inward towards the device housing in response to a force asserted against the second leg in the direction of the first leg.

4. The earphone set forth in claim 2 wherein the first leg is longer than the second leg and the first leg is curved along its length such that a central section of the first leg is curved inward towards the device housing.

5. The earphone set forth in claim 2 wherein the first and second legs are formed from a soft plastic material.

6. The earphone set forth in claim 2 wherein the first and second legs are joined together at a location spaced apart from the device housing by a distance between 1.0 and 5.0 mm.

7. The earphone set forth in claim 2 wherein the first and second legs are joined together at a location spaced apart from the device housing by a distance between 1.5 and 3.5 mm.

8. The earphone set forth in claim 1 wherein the stability anchor comprises a spherical or spheroid structure that protrudes away from an exterior surface of the device housing.

9. The earphone bud set forth in claim 8 wherein an apex of the spherical or spheroid structure is spaced apart from the device housing by a distance between 1.0 and 5.0 mm.

10. The earphone set forth in claim 8 wherein an apex of the spherical or spheroid structure is spaced apart from the device housing by a distance between 1.5 and 3.5 mm.

11. The earbud set forth in claim 1 wherein the stability anchor comprises an elongated structure having a length aligned with the primary acoustic port and an upper surface that is curved along a width of the elongated structure.

12. The earphone set forth in claim 10 an apex of elongated structure is spaced apart from the device housing by a distance between 1.0 and 5.0 mm.

13. The earphone set forth in claim 10 an apex of elongated structure is spaced apart from the device housing by a distance between 1.5 and 3.5 mm.

14. The earphone set forth in claim 8 wherein the stability anchor is formed from a silicone material.

15. The earphone set forth in claim 1 wherein the device housing comprises a speaker housing portion and a stem portion that is coupled to and extends away from the speaker housing portion and wherein the primary acoustic port is formed through the speaker housing portion.

16. An earphone comprising:
a device housing that defines an interior cavity and has a first roughness across along a majority of an external surface that defines a shape of the earphone;
a primary acoustic port formed through the device housing;
an acoustic driver disposed within the device housing and aligned to emit sound through the primary acoustic port; and
at least one friction zone formed along the device housing, the at least one friction zone protruding beyond the exterior surface of the device housing and having a second roughness that is greater than the first roughness.

17. The earphone set forth in claim 16 wherein the device housing is made from a hard, smooth plastic and the at least one friction zone is made from a relatively soft silicone or rubber material.

18. The earphone set forth in claim 16 wherein the device housing is made from a hard, smooth plastic and the at least one friction zone comprises a textured region formed at an exterior surface of the device housing.

19. The earphone set forth in claim 16 wherein the at least one friction zone has a textured surface in which the texture lays in a direction that creates more friction against a user ear when the earphone is removed from the ear than when the earphone is inserted into the ear.

20. The earphone set forth in claim 16 comprising a first friction region formed at a first location on the device housing and a second friction region formed at a second location on the device housing, where the first and second locations on the device housing are locations where, when the earphone is worn in an ear by a user, the device housing contacts front and rear portions of the ear, respectively.
